(19) United States
(12) Patent Application Publication
(10) Pub. No.: US 2010/0153396 A1
(43) Pub. Date: Jun. 17, 2010

(54) NAME INDEXING FOR NAME MATCHING SYSTEMS

(76) Inventors: Benson Margulies, Cambridge, MA (US); David Murgatroyd, Cambridge, MA (US); Bernard Greenberg, Cambridge, MA (US); Zhaohui Li, Cambridge, MA (US)

Correspondence Address: JACOBS & KIM LLP, 1050 WINTER STREET, SUITE 1000, #1082, WALTHAM, MA, 02451-1401, US

(21) Appl. No.: 12/528,618

(22) PCT Filed: Feb. 26, 2008
(86) PCT No.: PCT/US08/54999

§ 371 Date: Jan. 5, 2010

Related U.S. Application Data
(60) Provisional application No. 60/891,654, filed on Feb. 26, 2007.

(51) Int. Cl. G06F 17/30

(52) U.S. Cl. 707/737; 707/741; 707/E17.002; 707/E17.089

(57) ABSTRACT

Methods, systems and computer software program code products enabling the matching of a large number of names across any of a range of different languages comprise: receiving incoming names in any of a set of languages or scripts; generating high-recall keys based on the received incoming names; executing a full-text index process based on the generated high-recall keys; and looking up candidates for matching.

### CROSS-REFERENCE TO RELATED APPLICATIONS

This application for patent claims the priority benefit of U.S. Provisional Patent Application Ser. No. 60/891,654 filed Feb. 26, 2007 (Attorney Docket BAS-115-PR).

This application for patent incorporates by reference herein, as if set forth in their entireties, the following commonly owned United States patent applications:

Ser. No. 60/447,896 filed Feb. 14, 2003 (Attorney Docket BAS-101-US), entitled “Non-Latin Language Analysis, Name Matching, Transcription, Transliteration and Phonetic Search”;

Ser. No. 10/778,676 filed Feb. 13, 2004 (Attorney Docket BAS-110-US) also entitled “Non-Latin Language Analysis, Name Matching, Transcription, Transliteration and Phonetic Search” (non-provisional of the above-listed provisional); and

Ser. No. 11/387,107 filed Mar. 22, 2006 (Attorney Docket BAS-113-US), entitled “Linguistic Processing Platform, Architecture and Methods”.

Reference is also made herein to a number of products commercially available from Basis Technology Corp. of Cambridge, Mass., including the Transliteration Assistant, Rosette Name Translator, Rosette Name Indexer, Rosette Global Name Matcher, and Rosette Linguistics Platform. Additional product information and documentation is available at basistechnology.com, which information/documentation is incorporated herein by reference.

### FIELD OF THE INVENTION

The present invention relates generally to methods, systems, devices and software products for processing and extracting information from texts or other sources, and more particularly, to methods, systems, devices and software products operable to index, lookup and/or match names contained in or extracted from texts or other sources.

### BACKGROUND OF THE INVENTION

In an increasingly security-conscious world, interest continues to increase in computer-assisted review, processing and analysis of text, or other bodies of information in other forms, that may be found in any of a wide array of languages. One form of such analysis involves the extraction and matching of names contained in such texts or other sources to names on various lists of names of interest. This analysis is generally performed on human names, but may also be performed on non-human names, such as names of locations and the like.

Human names and name-containing bodies of information are problematic for a number of reasons. Consider, for example, a list of “persons of interest” generated by a US-based government agency using the Latin alphabet. A computer operator may be presented with a massive number of documents and wish to search those documents to determine whether any of them contain any of the listed names.

The easiest case is searching for an American name in English-language documents, presumably written using the Latin alphabet. Even in this easiest case, provisions must be made for possible misspellings or spelling variations, nicknames, inverted names, partial names, and the like.

The problem becomes significantly more complicated where the list of names includes names in a foreign language, or where the set of documents to be searched includes documents written in foreign languages using non-Latin writing systems. Any time a name is written in a non-native script, variations may be introduced. It will be apparent that in order to conduct an effective search in this situation, it is necessary to efficiently provide for these variations.

In recent years, various researchers have been developing and refining cross-script and cross-language name matching methods and systems. Such methods and systems are described, for example, in patent applications owned by the assignee of the present application for patent, Basis Technology Corp, of Cambridge, Mass., including those cited above and incorporated herein by reference. A central aspect of these methods is “matching”, for example, in comparing two names (e.g., one from a text or other source under analysis, and one from a list of names of interest) and calculating some measurement of similarity. However, there are limitations on previous approaches, chief among them being difficulties encountered in attempting to scale up to larger sets of names and across multiple languages while maintaining processing and storage speed and efficiency.

By way of example, previous approaches have involved emphasizing the value of working with names in native languages or scripts; and using algorithms to evaluate the similarity of names. These include sensitivity to name structure (surname, honorifics, etc), orthography, phonology, and can include statistical models. More particularly, previous name matching approaches have involved the following:
1) Names (in any supported language) are stored in a SQL database column;
2) An application server reads out all the names at startup, and creates an in-memory, name-based index;
3) Queries use a scoring algorithm to select hits;
4) The application is responsible for maintaining synchronization of memory and SQL.

Another approach, utilized in certain products of Basis Technology Corp., includes the following:
1) A large, constantly growing, database of English language documents is provided;
2) A Named Entity Extraction (NEE) process is used to extract names (examples of such processes are described in the above-referenced patent applications incorporated by reference herein);
3) Names are stored in a suitable name storage structure;
4) Other documents in a variety of languages arrive;
5) Names in arriving documents are extracted and stored;
6) Extracted names are looked up in the name storage structure;
7) The result is the generation of correlations between names in incoming documents and names in existing English documents.

While this particular configuration of NEE and its associated name storage structure is highly useful, it would be useful to extend that configuration to enable starting from a massive collection of names in many different languages, while enabling efficient processing of queries on names in any language or script.

While there are many possible applications of name matching that would benefit from construction of an index, i.e., an optimized data structure that can search or be used to search a large number of names for matches, there have been no effective means for generating such an index useful in cross-language or multiple language applications, particularly when thousands of names are to be processed.

The “Soundex” concept, in which a name is taken in, and a key is produced from it that encodes certain knowledge, has been known and used for many years. The Soundex phonetic algorithm for indexing names by their sound when pronounced in English is essentially described in U.S. Pat. Nos. 1,261,167 and 1,435,663 dating back to 1918 and 1922, respectively, incorporated herein by reference. Other commonly used phonetic algorithms for indexing words by their sound when pronounced in English include Metaphone, and Double Metaphone, described in “The Double Metaphone Search Algorithm”, C/C++ Users Journal, June 2000, incorporated herein by reference.

Soundex, however, is largely limited to Latin alphabet applications, and is of limited utility in cross-language or multiple language applications. In addition, known name matching systems typically operate by loading a set of names into memory, and then executing a linear scan using a matching algorithm. Such approaches cannot effectively scale up to very large indexes, for several reasons. For one, such approaches leave for the user the tasks (and computational and storage overhead) of actually storing the names and staging them in and out of memory. In addition, such approaches consume memory and processing time substantially in direct proportion to the number of names in the database. If the goal is to seek matches across thousands of names, for example, such a system may well be impractical.

To address these scaling issues, including storing and staging names, and memory and processing time, what is needed is a structure akin to a database, with the ability to store data persistently, to handle distribution and failure recovery, and with a performance characteristic significantly superior to that of previous systems (wherein time and resources required are proportional to the number of names).

It would be desirable to provide such solutions that can be readily interconnected with known, commonly-used data structures for storage and lookup.

In addition, it would be desirable to provide methods and systems that can incorporate available match-related knowledge (such as that generated in the Arabic-language matcher or Chinese reading database products available from the above-noted Basis Technology Corp.) into a key.

Still further, it would be desirable to provide such methods, systems and software products that enable the incorporation of selectable match parameters into the key-generation technique. This would be especially useful in combination with matchers in which results can be “tuned” by selection of match parameters.

### SUMMARY OF THE INVENTION

The present invention addresses the needs and issues described above, including the above-noted scaling issues such as the storing and staging of names, and memory and processing times, by providing enhanced name-indexing methods, systems, and computer program software code products adapted for execution in computer systems operable to extract names from text and to match at least one of the extracted names to at least one name on a list of names.

Beyond its application to names extracted from a text, it will be appreciated from the present description that the invention is also applicable to names coming from a variety of other sources. For example, names might be entered by hand directly into a database, effectively composing another list for “list vs. list” matching. As used herein, the term “source” refers generally to any of a wide range of sources or combinations thereof, whether a document, text, list, database, or other body or source of information.

More particularly, the invention is operable in such systems to enable the matching of a large number of names across any of a range of different languages, and can incorporate available match-related knowledge into a “key” that can be interconnected with known, commonly-used data structures for storage and lookup. The invention also enables the incorporation of selectable or “tunable” match parameters into the key-generating technique.

Methods: In one aspect, the invention comprises a method enabling the matching of a large number of names across any of a range of different languages, in which the method includes: (A) receiving incoming names in any of a set of languages or scripts; (B) generating high-recall keys based on the received incoming names; (C) executing a full-text index process based on the generated high-recall keys; and (D) looking up candidates for matching.

The looking up aspect can include: (1) looking up candidates for matching in a full-text index as a query; (2) generating, based on the results of the lookup, a set of candidate matching names; and (3) executing a matching algorithm on candidate matching names, thereby to generate a match output.

A method according to the invention can also include providing post-lookup processing comprising any of word order/alignment analysis, word classification, or word-by-word cross-script/language comparisons.

In a further aspect, a method according to the invention can include generating value scores for each of a plurality of candidates; applying to the scored candidate names a threshold test comprising a predetermined threshold value; and executing a matching algorithm on ones of the scored candidate names that pass the threshold test, thereby to generate a match output.

Various techniques can be used to generate the high-recall keys. In one practice of the invention, the generating can include (1) transliterating a received name to generate a transliterated output and (2) executing on the transliterated output an algorithm to generate high-recall keys. Other techniques can be used to generate the high-recall keys.

The aspect of executing an algorithm on the transliterated output to generate high-recall keys can include, in one possible practice of the invention, executing a Double Metaphone or other high-precision key generation algorithm on the transliterated output to generate the high-recall keys. In one practice of the invention, the phonetic alphabet can be a phonetic Latin alphabet

Systems: In another aspect, the invention can comprise an improvement to computer systems operable to extract names from text or other source and to match at least one of the extracted names to at least one name on a list of names, in which the improvement comprises: (A) an input means operable to receive incoming names in any of a set of languages or scripts; (B) a key generating means, in communication with the input means to receive the incoming names, and operable to generate high-recall keys in response thereto; (C) a full-text index means in communication with the key generating means and operable to execute a full-text index process based on the generated high-recall keys; and (D) a lookup/matching means in communication with the key generating means and operable to look up candidates for matching.

The lookup/matching means can include means for looking up candidates for matching in a full-text index as a query; means for generating, based on an output of the lookup means, a set of candidate matching names; and a matching means for executing a matching algorithm on candidate matching names, thereby to generate a match output.

In another aspect of the invention, the system can further include post-lookup processing means, in communication with the means for generating a set of candidate matching names, for providing any of word order/alignment analysis functions, word classification functions, or word-by-word cross-script/language comparisons.

A further improvement in accordance with the invention can include scoring means for generating value scores for each of a plurality of candidates, and threshold means for applying to the scored candidate names a threshold test comprising a predetermined threshold value, wherein the matching means is in communication with the threshold means and is operable to execute a matching algorithm on ones of the scored candidate names that pass the threshold test, thereby to generate a match output.

As noted above, various techniques can be used to generate the high-recall keys. In one practice of the invention, the key generating means can include a transliteration means operable to transliterate a received name into a phonetic alphabet to generate a transliterated output, and the key generating means can communicate with the transliteration means for receiving the transliterated output and for executing thereon an algorithm to generate high-recall keys. Other techniques can be used to generate the high-recall keys.

The high-recall key generating means can include, in one possible practice of the invention, a Double Metaphone means for executing a Double Metaphone algorithm on the transliterated output to generate the high-recall keys. In one practice of the invention, the phonetic alphabet can be a phonetic Latin alphabet.

Software/Program Code: A computer software program code-related aspect of the invention, adapted for execution in computer-assisted systems operable to extract names from a text or other source in a given language, can include: (A) input-handling computer program code executable by a computer to enable the computer to receive incoming names in any of a set of languages or scripts; (B) key generating computer program code executable by the computer to enable the computer to generate high-recall keys based on the received incoming names; (C) full-text index computer program code, executable by the computer to enable the computer to execute a full-text index process based on the generated high-recall keys; and (D) lookup/matching computer program code executable by the computer to enable the computer to look up candidates for matching.

In one aspect of the invention, the lookup/matching computer program code can include (1) computer program code executable by the computer to enable the computer to look up candidates for matching in a full-text index as a query; (2) computer program code executable by the computer to enable the computer to generate, based on an output of the candidate lookup process, a set of candidate matching names; and (3) computer program code executable by the computer to enable the computer to execute a matching algorithm on candidate matching names to generate a match output.

A computer program code product according to the invention can also include post-lookup processing computer program code executable by the computer to enable the computer to provide any of word order/alignment analysis functions, word classification functions, or word-by-word cross-script/language comparisons.

A computer program code product according to the invention can further include program code executable by the computer to enable the computer to generate value scores for each of a plurality of candidates; and program code executable by the computer to enable the computer to apply to the scored candidate names a threshold test comprising a predetermined threshold value; and wherein the matching computer program code is executable by the computer to enable the computer to execute a matching algorithm on ones of the scored candidate names that pass the threshold test, thereby to generate a match output.

As noted above, various techniques can be used to generate the high-recall keys. In one possible practice of the invention, the key generating computer program code can include transliteration computer program code executable by the computer to enable the computer to transliterate a received name into a phonetic alphabet to generate a transliterated output, and high-recall key generating computer program code executable by the computer to enable the computer to receive the transliterated output and execute thereon an algorithm to generate high-recall keys. Other techniques can be used to generate the high-recall keys.

In another possible practice of the invention, the high-recall key generating computer program code can include Double Metaphone computer program code executable by the computer to enable the computer to execute a Double Metaphone algorithm on the transliterated output to generate the low-precision keys. The phonetic alphabet can be a phonetic Latin alphabet.

As noted above, the invention can incorporate available match-related knowledge (such as that generated in the Arabic-language matcher or Chinese reading database products available from Basis Technology Corp.) in a key that can be interconnected with known, commonly-used data structures for storage and lookup. The invention also enables the incorporation of selectable or “tunable” match parameters into the key-generating technique, which can be especially useful in combination with matchers in which results can be tuned by selection of match parameters.

These and other aspects, examples, practices and embodiments of the invention will next be described in greater detail in the following Detailed Description of the Invention, in conjunction with the attached drawing figures.

### BRIEF DESCRIPTION OF THE DRAWINGS

FIG. 1 is a diagram illustrating variants of the name “Mao Zedong” using Latin and non-Latin writing systems.

FIG. 2 is a diagram illustrating variant Romanizations of the Arabic name “Mu'ammar Al-Qadhafi.”

FIG. 3 is a table illustrating various elements used in an Arabic name.

FIG. 4 is a diagram of an embodiment of a name indexing system according to one aspect of the present invention.

FIG. 5 is a schematic flow diagram of a name indexing technique according to a further aspect of the invention.

FIG. 6 is a schematic flow diagram of a name lookup technique according to a further aspect of the invention.

FIG. 7 is a schematic block diagram showing a hardware configuration in accordance with an embodiment of the invention, including a name indexing and lookup module.

FIG. 8 is a flowchart of a general technique according to described aspects of the present invention.

FIGS. 9 and 10 are schematic block diagrams of conventional digital processing systems suitable for implementing and practicing described aspects of the invention.

### DETAILED DESCRIPTION OF THE INVENTION

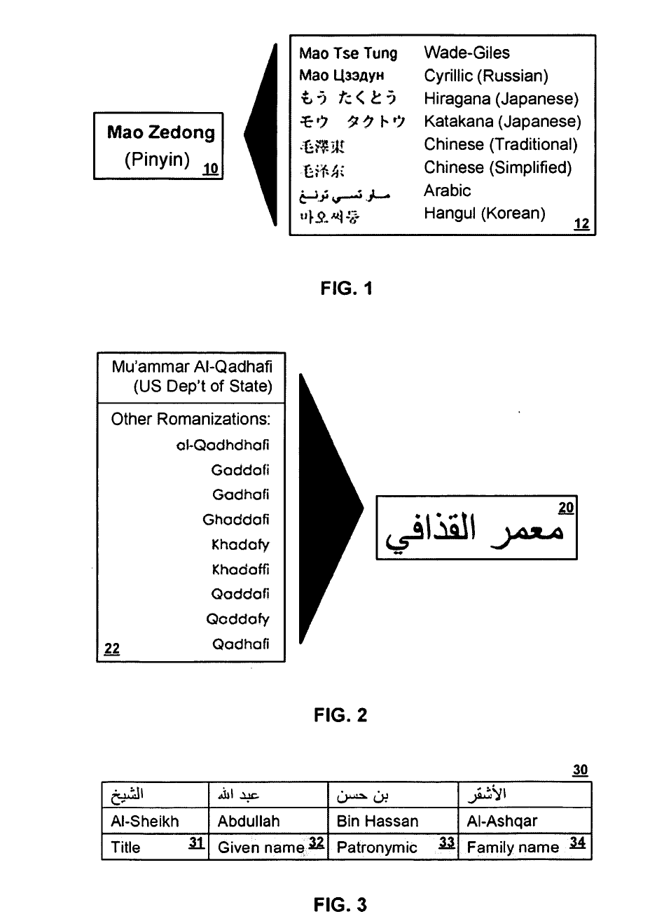

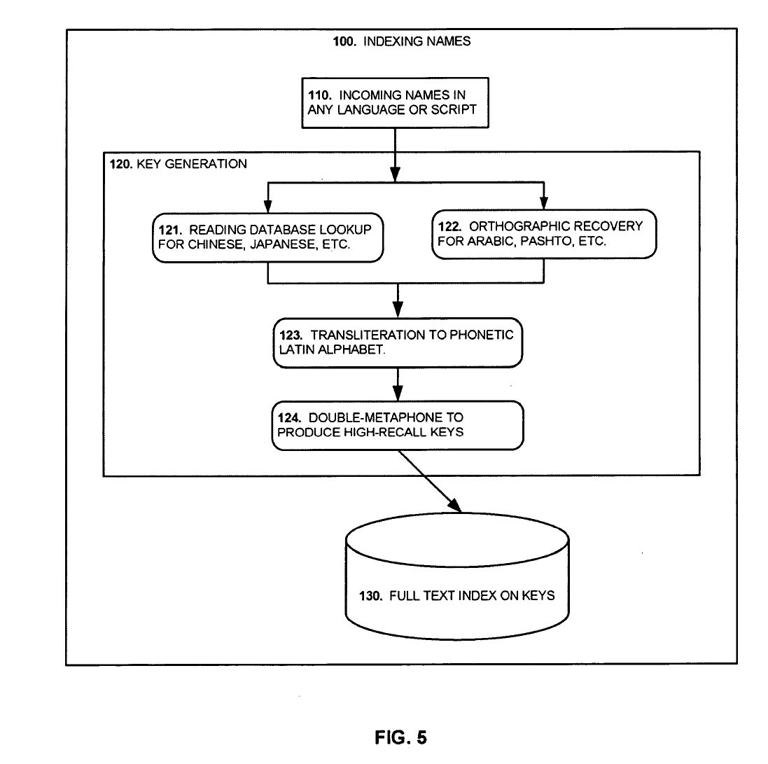

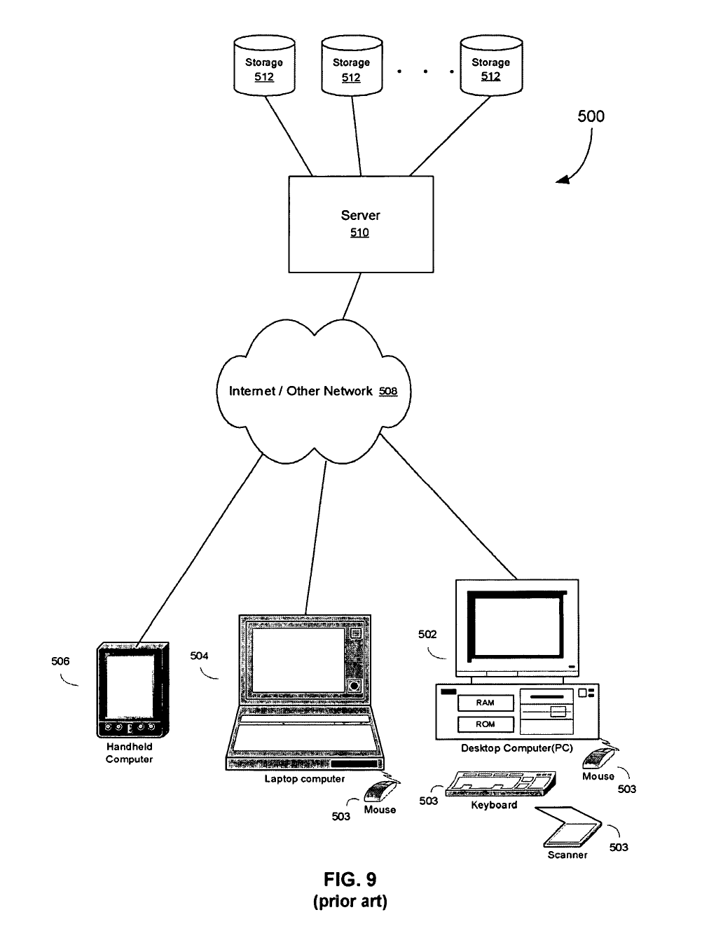

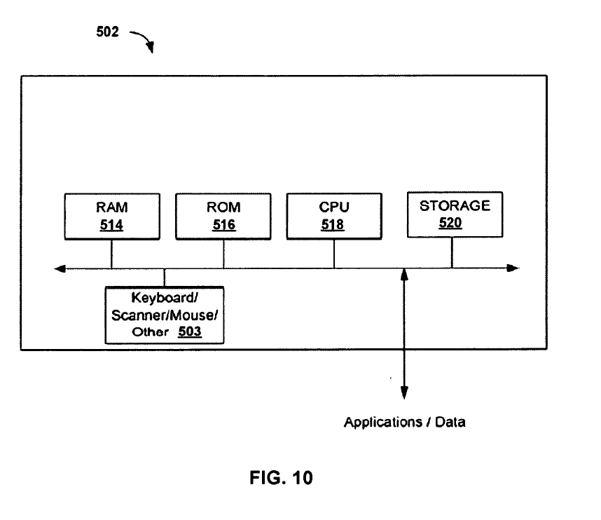

In the following Detailed Description, an overview of functional aspects of the invention is provided in connection with FIGS. 1, 2, 3 and 4, followed by further detailed discussion of examples and implementations of the invention (FIGS. 5-8), and examples of conventional digital processing environments in which the invention may be implemented (FIGS. 9 and 10).

### OVERVIEW OF THE INVENTION

As noted above, aspects of the present invention are directed to computer-based methods, systems and computer software program code products for efficiently increasing name search coverage and accuracy. The invention, as described in greater detail below, generates name variations to search for, by employing a linguistic-based approach, rather than the “scattershot” or “brute force” approach used in the prior art. In the following overview section, aspects of the invention are collectively referred to by the term Rosette Name Indexer (or “RNI”).

As described in greater detail below, in accordance with the present invention, the RNI returns query responses that are ranked results by relevancy, with a match score for automated analysis and processing. Where data is incomplete, the RNI returns partial matches. The RNI is capable of finding names of people, places and organizations, and can searches for names across a wide range of languages, including Middle Eastern and Far East languages in their native scripts and Romanized forms. Among the languages that can be processed by the RNI are the following: Arabic, Chinese, English, Japanese, Korean, Pashto, Persian, and Urdu. Among the scripts that can be processed by the RNI are the following: Arabic, Chinese (Traditional and Simplified), Japanese (Hiragana, Katakana, and Kanji), Korean (Hangul and Hanja), and Latin.

Also as described in greater detail below, the RNI can match names against lists or databases in different languages and writing systems and from foreign sources.

The operation of this aspect of the invention can better be understood with respect to a specific example. For the purposes of the present discussion, it is assumed that a list of names written in the Latin alphabet contains the name “Mao Zedong.” It is further assumed that there is a set of documents, or other source material, written in different languages and scripts, including English, Chinese, and Arabic, and it is desired to search these documents, or other source material, to determine whether any of them contain the name “Mao Zedong.” Such a search is complicated for a number of reasons.

First, even in the simplest case of searching for the name “Mao Zedong” in an English-language document written in the Latin alphabet, a complete search should include alternative Romanizations. For example, depending upon the Romanization system and style used, the name “Mao Zedong” may also be written in the Latin alphabet using a variety of spellings, including: “Mao Ze Dong,” “Mao Tse Tung,” “Mao Tse Tong,” and others.

Second, in searching a Chinese-language document, written using Chinese characters, a complete search should include the name “Mao Zedong” written in both Traditional and Simplified Characters, i.e.,

[symbol]

and [symbol]
respectively.

Third, in searching a non-English, non-Chinese document, a complete search should include the name “Mao Zedong” written in a foreign script, such as Arabic:

[symbol]

One embodiment of the present invention approaches such a search as follows, as illustrated in FIG. 1 et seq. FIG. 1 is a diagram illustrating a data entry for the name “Mao Zedong” 10, written in the Latin alphabet using Pinyin, and a partial list of variants 12 of the name using different scripts and Romanization systems. FIG. 2 is a diagram illustrating a data entry for the name “Mu'ammar Al-Qadhafi” 20, written in its native script, i.e., Arabic, and a partial list of variants 22 of how the name may be written using the Latin alphabet. As described herein, RNI uses knowledge of different cultures and writing systems, which allows it to handle spelling variations and errors, and non-standard Romanizations of names from many languages.

Unlike conventional systems that search lists containing billions of spelling variants, RNI can analyze the intrinsic structure of each name in its native language and performs an intelligent comparison based on linguistic, orthographic, and phonologic algorithms. This approach reduces the likelihood of both “false positives,” i.e., large numbers of meaningless hits, and “false negatives,” i.e., zero hits, or a failure to uncover relevant matches.

RNI is capable of processing different types of names, i.e., people, places, organizations, and so on, and is designed to be integrated into such applications as watch list management, fraud detection, money laundering, and geospatial analysis.

As discussed above, name variations may result from the use of different Romanizations of a name originally written in a foreign script. However, even in the native script there are nicknames, aliases, and optional name components which make name searching difficult. Arabic names may be written with honorifics, given name, family name, patronymics (son of x, father of y), tribal affiliation, city of birth, and more.

For example, FIG. 3 is a table 30 showing the different components of an Arabic name: “Al-Sheikh Abdullah Bin Hassan Al-Ashqar.” As shown in table 30, an Arabic name may include some or all of the following elements: Title 31, Given Name 32, Patronymic 33, Family Name 34, as well as other elements.

In Arabic, the name “Al-Sheikh Abdullah Bin Hassan Al-Ashqar” may appear in a number of different forms, including:
1. Al-Sheikh Abdullah Al-Ashqar (no patronymic);
2. Abdullah Al-Ashqar (no title, no patronymic);
3. Al-Sheikh Abdullah Bin Hassan Bin Mohammad Al-Ashqar (with grandfather's patronymic).

The present invention and its RNI aspects provide for these types of name variations, as described in greater detail below. In addition, RNI is cognizant of how sounds of a foreign name can be interpreted in many ways in a non-native script. For example, RNI is cognizant that the Arabic script

[symbol]

can be interpreted using the Latin alphabet as a number of variants, including “Mouqtada alsader” or “Muktada El-sader.” The Chinese characters [symbol]
can be interpreted using the Latin alphabet as a number of variants, including “Mao Zedong” or “Mao Tse Dong,” and can also be interpreted using Arabic script as a number of variants including, for example: [symbol]
or

[symbol]

According to a further aspect of the invention, matching names are returned with a confidence-ranked match score from 0% to 100%, to guide subsequent handling of the results. Thus, a minimum match threshold may be set to constrain the quality of the results returned. Through an application programming interface (API) provided in the RNI system, it is possible to access other information associated with a given entry, such as relationships and geographic locations to help identify specific individuals and places.

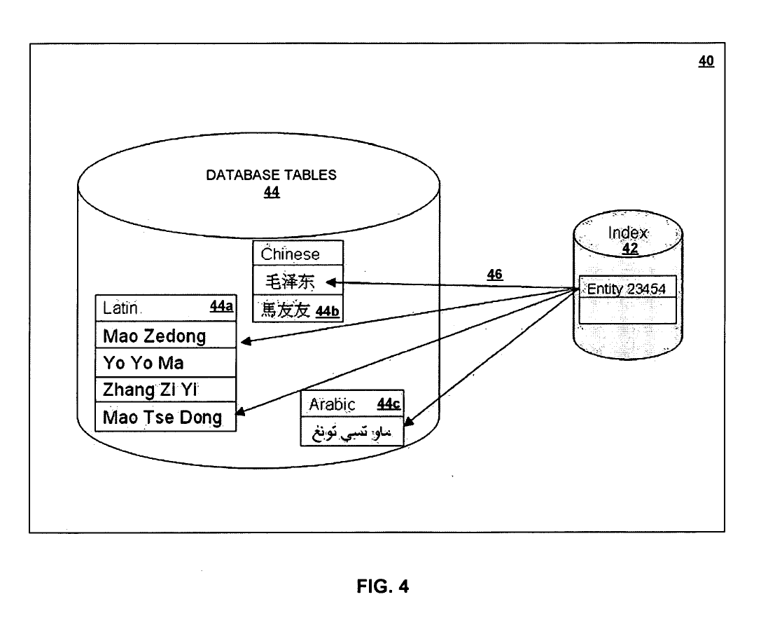

FIG. 4 is a diagram of an embodiment 40 of the present invention in the RNI context. As shown in FIG. 4, the RNI index 42 may be implemented in conjunction with any database of names 44, leaving the original data untouched. In the exemplary database 44, names are stored using the Latin alphabet 44a, Chinese characters 44b, and Arabic script 44c. The RNI index 42 provides pointers 46 to matching names within the database, ready for a fuzzy name search. When not all lexical components of a name match, RNI aligns input names with entries to recognize partial matches, With each update of the database, the RNI index can also be automatically updated.

### DETAILED IMPLEMENTATIONS OF THE INVENTION

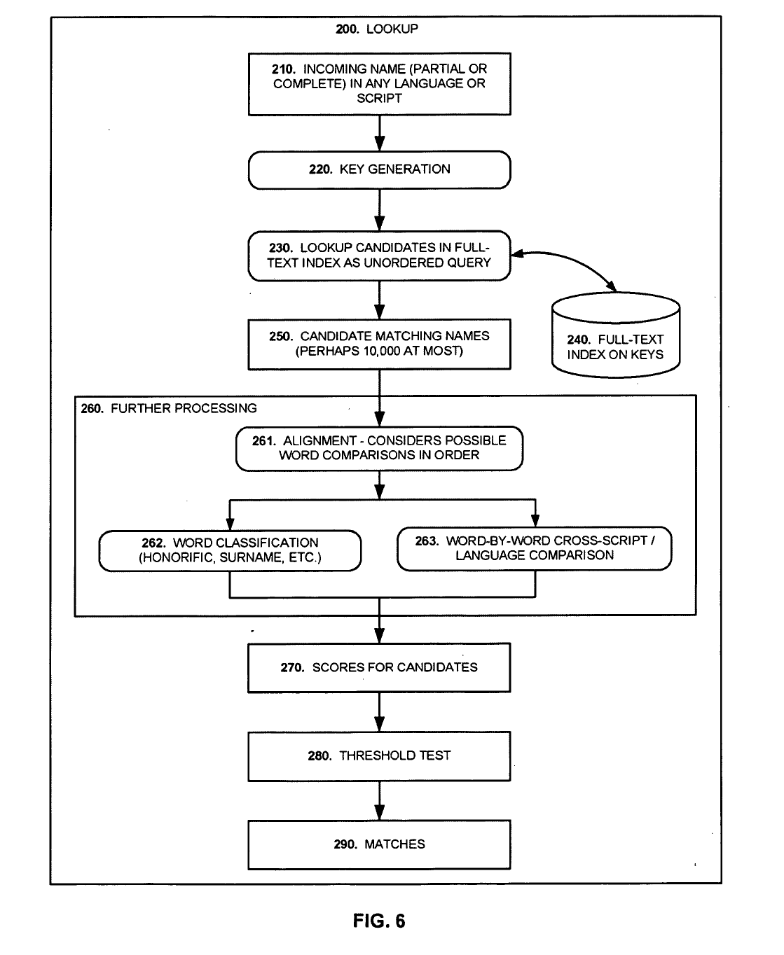

The solution and technical advantages provided by the present invention, including the RNI aspects discussed above, are based on the idea of splitting the indexing and lookup process into two parts, illustrated schematically in FIGS. 5 and 6. FIG. 5 is a schematic flow diagram of aspects of an embodiment of the present invention relating to name indexing, and FIG. 6 is a schematic flow diagram of aspects of embodiment of the present invention relating to a lookup process, utilizing name indexing aspects like those shown in FIG. 5.

In conventional approaches, as discussed above, an entire name is converted into a key that, when compared, finds exactly the names that are desired to be returned as matches. The present invention stems from the realization that the system need not convert an entire name into a key. Instead, as illustrated in FIG. 5 and discussed in greater detail below, it is sufficient to generate a key that finds a sufficiently small set of candidate names that an existing matching system can be adapted, as illustrated in FIG. 6, to search the candidates for the matches.

In one embodiment of the invention, a relatively conventional index process can be applied to do much of the necessary processing, enabling the system to then focus on the results of that indexing. A preliminary question is how to apply the relatively conventional index process. In addressing this, it is noted that there are essentially two aspects to name matching: word-level comparison and name-level comparison.

The first step is to exclude name-level considerations from the relatively conventional index process. This is accomplished in the present invention by treating the indexing problem as a full-text indexing problem, for example, as set forth as element 130 of FIG. 5, discussed in greater detail below.

A name can be considered to be a vector of tokens, just as a document can be considered to be a vector of tokens. (See Basis Technology patent applications noted above and incorporated herein by reference.) Thus, when looking for a name, the process begins by identifying all the names in the database that have at least one word in common with the query. All considerations of token-order, and surnames and titles, are deferred until the detailed examination of the subset. These latter aspects are discussed below in connection with elements 260-263 of FIG. 6.

The second step is to transform the original names into tokens that any full-text index can handle, e.g., tokens of ASCII. The problem here is essentially to take as an input a token in any language or script, and derive from it a token with some specific matching characteristics. In accordance with the present invention, this means the following: two derived tokens should match if any of our various matching algorithms, at any useful settings, would treat them as matching. In other words, the word-level match should have at least as much recall as the word-level matching in the detailed algorithms (referred to herein as “high-recall”); although it may have less precision. (The term “recall” is generally used, in a database context, to refer to the relationship between the number of relevant records retrieved and the number of relevant records in a database.)

The following is an example of this process.

Consider the Arabic name:

[symbol]

Using, for example, a transliteration product available from Basis Technology and described in the patent applications noted above and incorporated herein by reference, that name is transliterated to ‘al-imaam maalik’. See, e.g., step 123 of FIG. 5, discussed below.

Now, it is assumed that the following operations are performed:

(1) Convert that transliteration result into keys: AL AMM MLK (see, e.g., step 124 of FIG. 5); and

(2) Index that with a full-text index (see, e.g., step 130 of FIG. 5).

It is noted that in this Arabic-based example, it is desired to either filter out the definite article or allow it to combine itself with the following word.

Next, that string of three tokens is placed into a full-text index as an index entry.

Accordingly, when a query is executed, any name containing any other Arabic (or Korean, or Chinese) word that turns into AMM will hit this index entry, and it will become a candidate match for further consideration, as will be discussed in connection with elements 250 et seq. of FIG. 6.

The method by which the keys “AL AMM MLK” are arrived at is as follows: First, the Rosette Name Translator, available from Basis Technology Corp., is employed to convert the received native script (110 of FIG. 5) into some transliteration system that is (1) ASCII or similar, and (2) biased toward pronunciation rather than fidelity or reversibility. (This is shown at block 123 of FIG. 5.) Next, a conventional Double Metaphone technique (124 of FIG. 5) is employed to convert the results and thereby generate a high-recall key.

One aspect of the invention is thus based on the use of phonetic keys, generated in a particular manner, as search terms in a full-text index, in the form of a query, which may be an unordered query (230 of FIG. 6). The resulting candidate matching names (250) can then be further processed (260), scored (270), subjected to a threshold test (280), and matched (290). Each of these aspects will next be discussed in greater detail in connection with the attached FIGS. 5 and 6. (As also discussed elsewhere in this document, the invention can be practiced without transliteration and a phonetic alphabet, and the use of transliteration and a phonetic alphabet in one aspect or practice of the invention is but one method of generating high-recall keys; other techniques can be used to generate the high-recall keys.)

FIGS. 5 and 6 are now described in greater detail. FIG. 5 is a schematic flowchart of a name indexing process 100 in accordance with one practice of the present invention. The process 100 begins by taking in as an input 110 a set of names in any language or script. This input can be generated, for example, by processing documents using a Named Entity Extraction (NEE) process, such as that available from Basis Technology Corp., to extract the names. Examples of such processes are described in the above-referenced patent applications incorporated by reference herein.

The incoming names are passed to a key generation process or module 120. In the illustrated embodiment, key generation process or module 1004 includes a number of subprocesses or modules. First, as applicable, a process of reading a database lookup for Chinese, Japanese or the like 121 can be applied. Also as applicable, an orthographic recovery process 122 can be applied for Arabic, Pashto, and similar languages. Examples and aspects of such processes 121 and 122 are discussed in the Basis Technology patent applications cited above and incorporated herein by reference, and the underlying principles of such processes are known in the art.

Referring again to FIG. 5, the output of processes 121 and 122 are passed to process or module 123, in which the output is transliterated to a phonetic Latin alphabet in an ASCII representation or similar. As noted above, the Rosette Name Translator available from Basis Technology Corp. is operable to convert the received native script 110 and transliterate it into ASCII or the like. (As noted elsewhere in this document, the invention can be practiced without transliteration and a phonetic Latin alphabet, and the use of transliteration and a phonetic Latin alphabet in one aspect or practice of the invention is but one approach to generating high-recall keys; other techniques can be used to generate the high-recall keys.)

Next, a Double Metaphone or similar process is applied 124 to the output of process or module 123, to produce high-recall keys. (Again, as noted elsewhere in this document, the use of a Double Metaphone technique or similar process is but one example of a method to generate high-recall keys; and as with the techniques of transliteration to a phonetic Latin alphabet, those skilled in the art will understand and appreciate that other techniques may be employed.)

The high-recall keys generated at process or module 124 can then be used in process or module 130, i.e., full-text index on the high-recall keys generated as the output of the Double Metaphone or similar process 124.

Those skilled in the art will understand that when a data store is combined with a key production algorithm, a persistent high-recall index or key is obtained. This index or key is operable irrespective of how the data store is implemented. Thus, data classes that implement the persistent high-recall index interface take stored objects in their constructors, and thereby, knowledge of the key production algorithm is incorporated into the key. This aspect is a technically significant advantage of the present invention.

Having described one practice of name indexing in accordance with the invention, the present description now turns to the lookup and matching aspects depicted in FIG. 6. In a typical embodiment of the invention, a data object NameIndex is defined, which is at the top of the stack, and combines a persistent high-recall index with a name matching system, such as an existing name matching system of Basis Technology Corp. As will next be discussed in connection with FIG. 6, this passes a query to the high-recall index to retrieve a set of candidate names. The object loads the names into the name matcher, and then runs a matching process.

Referring now to FIG. 6, there is shown a schematic flow diagram of lookup and matching aspects in accordance with the invention, which build on the indexing aspects and output of the configuration shown in FIG. 5.

As shown in FIG. 6, lookup process 200 begins at process or module 210 with taking as an input one or more incoming names, either partial or complete, in any language or script.

The incoming name is passed to a key generation process or module 220, which can utilize, or be based on, key generation aspects like those depicted in key generation module or process 120 of FIG. 5. These aspects may include reading a database lookup for Chinese, Japanese or the like (121 of FIG. 5), applying orthographic recovery for Arabic, Pashto or the like (122 of FIG. 5), transliteration to a phonetic Latin alphabet in ASCII representation or the like (123 of FIG. 5), and applying Double Metaphone or similar process to produce high-recall keys (124 of FIG. 5).

Once key generation 220 has been implemented, the process moves to module or process 230, i.e., candidates are looked up in a full-text index as a query. Execution of this process or module 230 results in candidate matching names (element 250 of FIG. 6). The number of candidate matching names generated can be selected by the implementer with an awareness of system resource levels and system performance, and may in a typical implementation be 10,000 or fewer.

Outside of the name matching and name indexing field of the present invention, techniques and methods for looking up candidates in a full-text index via a query (albeit a query consisting of a keyword, question or sentence) are known in the art. See, for example, U.S. Pat. No. 6,775,666 of Microsoft Corporation, issued Aug. 10, 2004, and incorporated herein by reference, which relates to methods and systems for searching index databases, wherein the searchable content database includes a full-text index, and the search component includes a results list database, an exact match search, a natural language processor (NLP), and a full-text search.

Other examples of utilizing queries for lookup are U.S. Pat. No. 6,285,999 (issued Sep. 4, 2001, entitled “Method for Node Ranking in a Linked Database”) and U.S. Patent Application Publication 2005/0071741 (published Mar. 31, 2005 and entitled “Information Retrieval Based on Historical Data”) assigned to The Board of Trustees of the Leland Stanford Junior University and licensed to Google Inc. of Mountain View, Calif. Each of the herein-noted documents is incorporated by reference herein as if set forth in its entirety.

The output of process or module 230 can also be used in process 240, i.e., full-text index on keys, which can utilize aspects analogous to process or module 130 of FIG. 5.

As also shown in FIG. 6, the candidate matching names from process or module 250 can then be further processed in module or process 260, which can include submodules or processes of alignment 261 (which considers possible word comparisons in order); word classification 262 (which considers honorifics, surnames or the like, such as in Arabic and similar languages); and word-by-word cross-script/language comparison 263. Examples of the structural and procedural aspects of such modules or processes are described in the Basis Technology patent applications cited above and incorporated herein by reference.

The output of process or module 260 is then passed to a scoring module or process 270, which generates scores for the various candidate matching names.

Examples of methods for generating scores for matches are set forth in the above-referenced U.S. Pat. No. 6,285,999, incorporated herein by reference.

The output of scoring process or module 270 can then be passed to a thresholding process or module 280 and a matching process or module 290. These thresholding and matching processes can be implemented using techniques described in the above-referenced patent applications of Basis Technology, and/or the above-cited patents of others, each of which is incorporated herein by reference

Those skilled in the art will also recognize that variations of these techniques can be employed to allow “tuning” of key generation and indexing.

In addition, it is known that users of various document and language analysis systems have expressed concerns about the possibility that someone might intentionally use an “implausible” spelling, either inadvertently or intentionally, and that a conventional analysis algorithm will not detect such an occurrence. In order to address this concern, the present invention can accommodate a database of manually-collected “extra” spellings. Before presenting a name to the database for a lookup, the system or user can look for it in the manual list to “normalize” it to a more conventional, or even native, spelling. The Basis Technology Name Matcher (NM) described and cited above can have value as part of this process.

Various other decisions can be left to the implementer. For example, it may be useful or appropriate in certain implementations to use stop words; to discard keys corresponding to extremely common name elements, such as Park in Korean or Mohammed in Arabic, or risk having too many hits in the full-text index, but at the possible cost of discarding useful Arabic words that share a token with, e.g., Park. Moreover, once the system is storing names in a persistent database, it is logical to also permit other types of queries (beyond merely “fuzzy” name queries). These may include permitting users to restrict results to only names in a single language or script, or retrieve a name by its unique key. The present invention can be adapted to restrict queries by any such items.

Using the configuration illustrated in FIG. 6, in one practice of the invention, a name lookup engine (NLE) in accordance with the invention can include the following:

1) The NLE stores names in persistent storage;

2) The NLE has a two-level lookup system;

3) Of these, the lower level is low precision, based on a full-text index such as Lucene (but others can be integrated);

4) The upper level is a Name Matcher (NM) scoring algorithm (Name Matcher processes are discussed in detail in the above referenced, commonly owned U.S. patent applications incorporated by reference herein);

5) The result is tunable, very high performance (for example, 2.9 million Wikipedia titles on a laptop).

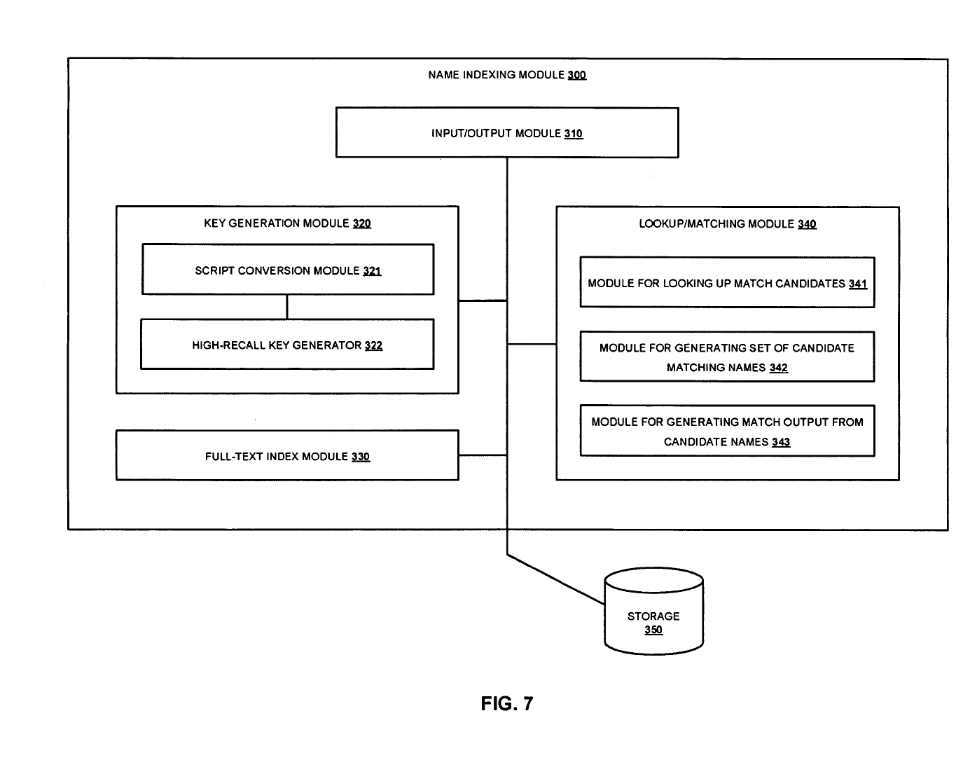

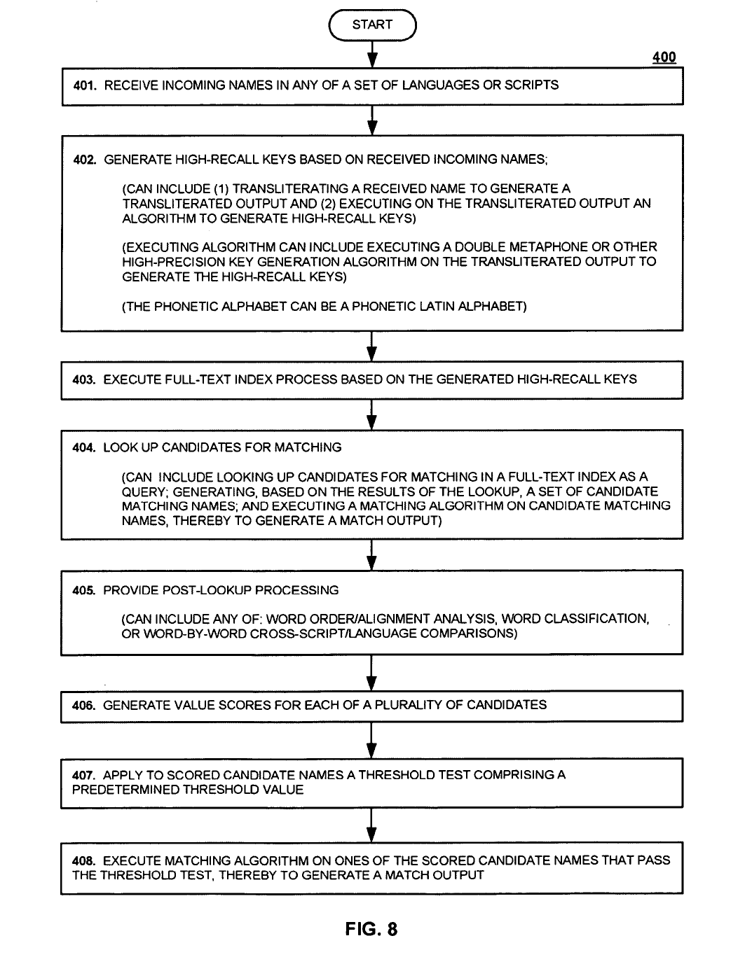

Examples, embodiments and implementations of the invention can also be equivalently described in terms of processing modules within a PC or other computing environment, for executing the functions described above. By way of example, FIG. 7 is a schematic block diagram showing a hardware configuration in accordance with an embodiment of the invention, including a name indexing and lookup module. More particularly, FIG. 7 depicts a name indexing module 300 embodying various described aspects of the present invention. Within name indexing module 300, an input/output module 310 receives name inputs and other inputs and described above. Key generation module 320 generates the above-described keys and includes a transliteration/script conversion module 321 and a high-recall key generator 322. Full-text index module 330 is used to analyze names at the “full-text” level as described above. Lookup/matching module 340 provides the above-described lookup and matching functions, and includes the following submodules: module 341 for looking up match candidates; module 342 for generating a set of candidate matching names; and module 343 for generating match output from candidate names. Storage 350 is provided to store data, as described above. Those skilled in the art will understand that each of these modules can be configured and implemented in accordance with the present invention, using conventional computing devices and structures. Digital processing environments in which the present invention can be implemented are discussed below, in connection with FIGS. 9 and 10, following a discussion of FIG. 8.

FIG. 8 is a flowchart of a general technique 400 according to various aspects of the present invention discussed above. The example shown in FIG. 8 is but one example according to the invention (of which numerous variations are possible and within the scope of the present invention), and includes the following aspects:

Box 401: Receive incoming names in any of a set of languages or scripts.

Box 402: Generate high-recall keys based on received incoming names. As shown in box 402, in one practice of the invention this aspect can include (1) transliterating a received name to generate a transliterated output and (2) executing on the transliterated output an algorithm to generate high-recall keys. This aspect can further include executing a double metaphone or other high-precision key generation algorithm on the transliterated output to generate the high-recall keys. The phonetic alphabet can be a phonetic Latin alphabet. (As noted elsewhere in this document, other techniques can be used to generate the high-recall keys.)

Box 403: Execute full-text index process based on the generated high-recall keys.

Box 404: Look up candidates for matching. This aspect can include looking up candidates for matching in a full-text index as a query; generating, based on the results of the lookup, a set of candidate matching names; and executing a matching algorithm on candidate matching names, thereby to generate a match output.

Box 405: Provide post-lookup processing. This aspect can include any of: word order/alignment analysis, word classification, or word-by-word cross-script/language comparisons.

Box 406: Generate value scores for each of a plurality of candidates.

Box 407: Apply to scored candidate names a threshold test comprising a predetermined threshold value.

Box 408: Execute matching algorithm on ones of the scored candidate names that pass the threshold test, thereby to generate a match output.

Digital Processing Environments in which the Invention can be Implemented

The following discussion, in connection with FIG. 9 (Prior Art network architecture) and FIG. 10 (Prior Art PC or workstation architecture), describes various digital processing environments in which the present invention may be implemented and practiced, typically using conventional computer hardware elements.

The discussion set forth above in connection with FIGS. 1-8 described methods, structures, systems, and software products in accordance with the invention. It will be understood by those skilled in the art that the described methods and systems can be implemented in software, hardware, or a combination of software and hardware, using conventional computer apparatus such as a personal computer (PC) or equivalent device operating in accordance with (or emulating) a conventional operating system such as Microsoft Windows, Linux, or Unix, either in a standalone configuration or across a network. The various processing aspects and means described herein may therefore be implemented in the software and/or hardware elements of a properly configured digital processing device or network of devices. Processing may be performed sequentially or in parallel, and may be implemented using special purpose or re-configurable hardware.

As an example, FIG. 9 attached hereto depicts an illustrative digital processing network 500 in which the invention can be implemented. Alternatively, the invention can be practiced in a wide range of computing environments and digital processing architectures, whether standalone, networked, portable or fixed, including conventional PCs 502, laptops 504, handheld or mobile computers 506, or across the Internet or other networks 508, which may in turn include servers 510 and storage 512, as shown in FIG. 9.

As is well known in conventional computer software and hardware practice, a software application configured in accordance with the invention can operate within, e.g., a PC or workstation 502 like that depicted schematically in FIG. 10, in which program instructions can be read from CD ROM 516, magnetic disk or other storage 520 and loaded into RAM 514 for execution by CPU 518. Data can be input into the system via any known device or means, including a conventional keyboard, scanner, mouse or other elements 503.

Those skilled in the art will understand and appreciate that names, text, documents and other sources of information that can be processed by the present invention can be easily entered into a database or otherwise processed or utilized by a PC or other computing system like that shown in FIGS. 9 and 10. Such data entry or other basic processing techniques, whether using a keyboard, mouse, scanner or other conventional PC or computing devices, are well known in the art.

Those skilled in the art will understand that various method aspects of the invention described herein can also be executed in hardware elements, such as an Application-Specific Integrated Circuit (ASIC) constructed specifically to carry out the processes described herein, using ASIC construction techniques known to ASIC manufacturers. Various forms of ASICs are available from many manufacturers, although currently available ASICs do not provide the functions described in this patent application. Such manufacturers include Intel Corporation of Santa Clara, Calif. The actual semiconductor elements of such ASICs and equivalent integrated circuits are not part of the present invention, and are not be discussed in detail herein.

Those skilled in the art will also understand that method aspects of the present invention can be carried out within commercially available digital processing systems, such as workstations and PCs as depicted in FIG. 10, operating under the collective command of the workstation or PC's operating system and a computer program product configured in accordance with the present invention. The term “computer program product” can encompass any set of computer-readable programs instructions encoded on a computer readable medium. A computer readable medium can encompass any form of computer readable element, including, but not limited to, a computer hard disk, computer floppy disk, computer-readable flash drive, computer-readable RAM or ROM element or any other known means of encoding, storing or providing digital information, whether local to or remote from the workstation, PC or other digital processing device or system. Various forms of computer readable elements and media are well known in the computing arts, and their selection is left to the implementer.

Those skilled in the art will also appreciate that a wide range of modifications and variations of the present invention are possible and within the scope of the invention. The invention can also be employed for purposes, and in devices and systems, other than those described herein. Accordingly, the foregoing is presented solely by way of example, and the scope of the invention is not to be limited by the foregoing examples, but is limited solely by the scope of the following patent claims.

We claim:

1. In a computer-assisted system operable to extract names from a source and to match at least one of the extracted names to at least one name on a list of names, an improvement enabling matching of a large number of names across any of a range of different languages, the improvement comprising:
(A) input means operable to receive incoming names in any of a set of languages or scripts;
(B) key generating means, in communication with the input means, and operable to generate high-recall keys based on the incoming names;
(C) full-text index means in communication with the key generating means and operable to execute a full-text index process based on the generated high-recall keys; and
(D) lookup/matching means in communication with the key generating means and operable to look up candidates for matching, the lookup/matching means comprising:
(1) means for looking up candidates for matching in a full-text index;
(2) means for generating, based on an output of the lookup means, a set of candidate matching names; and
(3) matching means for executing a matching algorithm on candidate matching names, thereby to generate a match output.

2. The improvement of claim 1 further comprising post-lookup processing means, in communication with the means for generating a set of candidate matching names, for providing any of word order/alignment analysis functions, word classification functions, or word-by-word cross-script/language comparisons.

3. The improvement of claim 2 further comprising:
(1) scoring means for generating value scores for each of a plurality of candidates;
(2) threshold means for applying to the scored candidate names a threshold test comprising a predetermined threshold value; and
(3) wherein the matching means is in communication with the threshold means and is operable to execute a matching algorithm on ones of the scored candidate names that pass the threshold test, thereby to generate a match output.

4. The improvement of claim 3 wherein the key generating means comprises transliteration means operable to transliterate a received name into a phonetic alphabet to generate a transliterated output, and wherein the key generating means is operable to receive the transliterated output and execute thereon an algorithm to generate the high-recall keys.

5. The improvement of claim 4 wherein the key generating means comprises double-metaphone means for executing a double-metaphone algorithm on the transliterated output to generate the high-recall keys.

6. The improvement of claim 5 wherein the phonetic alphabet is a phonetic Latin alphabet.

7. In a computer-assisted system operable to extract names from a source and to match at least one of the extracted names to at least one name on a list of names, a method enabling matching of a large number of names across any of a range of different languages, the method comprising:
(A) receiving incoming names in any of a set of languages or scripts;
(B) generating high-recall keys based on the received incoming names,
(C) executing a full-text index process based on the generated keys; and
(D) looking up candidates for matching, the looking up comprising:
(1) looking up candidates for matching in a full-text index;
(2) generating, based on the results of the lookup, a set of candidate matching names; and
(3) executing a matching algorithm on candidate matching names, thereby to generate a match output.

8. The method of claim 7 further comprising:
providing post-lookup processing comprising any of word order/alignment analysis, word classification, or word-by-word cross-script/language comparisons.

9. The method of claim 8 further comprising:
(1) generating value scores for each of a plurality of candidates;
(2) applying to the scored candidate names a threshold test comprising a predetermined threshold value; and
(3) executing a matching algorithm on ones of the scored candidate names that pass the threshold test, thereby to generate a match output.

10. The method of claim 9 wherein generating high-recall keys comprises:
(1) transliterating a received name into a phonetic alphabet to generate a transliterated output, and
(2) executing on the transliterated output an algorithm to generate the high-recall keys.

11. The method of claim 10 wherein executing an algorithm on the transliterated output to generate high-recall keys comprises executing a double-metaphone algorithm on the transliterated output to generate the high-recall keys.

12. The method of claim 11 wherein the phonetic alphabet is a phonetic Latin alphabet.

13. In a computer-assisted system operable to extract names from a source in a given language and to match at least one of the extracted names to at least one name on a list of names, a computer program product operable to enable the matching of a large number of names across any of a range of different languages, the computer program product comprising computer program code stored on a computer-readable physical medium, the computer program product further comprising:
(A) input-handling computer program code executable by a computer to enable the computer to receive incoming names in any of a set of languages or scripts;
(B) key generating computer program code executable by the computer to enable the computer to generate high-recall keys based on the received incoming names,
(C) full-text index computer program code, executable by the computer to enable the computer to execute a full-text index process based on the generated high-recall keys; and
(D) lookup/matching computer program code executable by the computer to enable the computer to look up candidates for matching, the lookup/matching computer program code comprising:
(1) computer program code executable by the computer to enable the computer to look up candidates for matching in a full-text index;
(2) computer program code executable by the computer to enable the computer to generate, based on an output of the candidate lookup process, a set of candidate matching names; and
(3) computer program code executable by the computer to enable the computer to execute a matching algorithm on candidate matching names to generate a match output.

14. The computer program product of claim 13 further comprising post-lookup processing computer program code executable by the computer to enable the computer to provide any of word order/alignment analysis functions, word classification functions, or word-by-word cross-script/language comparisons.

15. The computer program product of claim 14 further comprising:
(1) scoring computer program code executable by the computer to enable the computer to generate value scores for each of a plurality of candidates;
(2) threshold computer program code executable by the computer to enable the computer to apply to the scored candidate names a threshold test comprising a predetermined threshold value; and
(3) wherein the matching computer program code is executable by the computer to enable the computer to execute a matching algorithm on ones of the scored candidate names that pass the threshold test, thereby to generate a match output.

16. The computer program product of claim 15 wherein the key generating computer program code comprises:
(1) transliteration computer program code executable by the computer to enable the computer to transliterate a received name into a phonetic alphabet to generate a transliterated output, and
(2) computer program code executable by the computer to enable the computer to receive the transliterated output and execute thereon an algorithm to generate high-recall keys.

17. The computer program product of claim 16 wherein the high-recall key generating computer program code comprises double-metaphone computer program code executable by the computer to enable the computer to execute a double-metaphone algorithm on the transliterated output to generate the high-recall keys.

18. The computer program product of claim 17 wherein the phonetic alphabet is a phonetic Latin alphabet.
